(19) United States
(12) Patent Application Publication
(10) Pub. No.: US 2016/0055598 A1
(43) Pub. Date: Feb. 25, 2016

(54) Restaurant Guest Service System And Method

(71) Applicant: Purna Chander Ramini, Bentonville, AR (US)

(72) Inventor: Purna Chander Ramini, Bentonville, AR (US)

(21) Appl. No.: 14/468,141

(22) Filed: Aug. 25, 2014

(51) Int. Cl. G06Q 50/12; G06Q 20/14; G06Q 30/06

(52) U.S. Cl. CPC G06Q 50/12; G06Q 30/0633; G06Q 20/14

(57) ABSTRACT

The present disclosure (here) is a system and method of placing food/beverage orders at a table in a restaurant by guests using electronic mobile devices such as but not limited to smart phones or tablets connected to internet, that has capability to scan QR code (2D barcode) and a web browser. This system and method includes placement of ‘Host/Waiter QR code’ at a table that uniquely identifies a specific table in a restaurant, authenticated host/waiter scans using electronic mobile device to open or close food/beverage orders process for that specific table in a restaurant. It includes placement of ‘Guest QR codes’ at a table that uniquely identifies each guest seat at a specific table in a restaurant, which each authenticated guest at that table scans to initiate food/beverage orders for that specific guest. It includes placement of ‘Item QR code’ next to each item in a restaurant menu that uniquely identifies a specific item on a menu in a specific restaurant which each authenticated guest scans to view specific item's information and/or make selection of that item. It includes a hosted system (Computer Server & Software) connected to the internet, that performs operations required in food/beverage orders process.

### BACKGROUND

1. Field of Invention

The present invention automates display of restaurant menu item's information, guest food/beverage order & delivery process at the table using QR Codes (2D barcodes) and electronic mobile devices such as but not limited to smart phones or tablets that has QR Code (2D barcode) scan capability with web browser.

2. Related Art

At present, menu provided at the tables in most of the restaurants are in printed form with minimal information about items and only few items on the menu show pictures, with no capabilities to show short preparation video, chefs profile, allergy information, ingredients or detailed description of the items.

Guests food/beverage order process at the table is manual in most of the restaurants, which is time consuming, prone to errors and very little scope for made to order options.

Food and beverage order process at the table in restaurants is currently automated for the hosts/waiters who utilize electronic mobile devices such as smart phones and tablets, where hosts/waiters enter the order information based on the verbal conversation with guests, which do not utilize QR Codes (2D barcodes) capabilities.

Food and beverage order process at the table in restaurants is currently automated for the guests using electronic touch screen devices provided at the table by the restaurants do not utilize QR Codes (2D barcodes) capabilities, which is not cost effective for most of the restaurant operators/owners.

### SUMMARY

Exemplary embodiments of the invention utilize QR Codes(2D barcodes) in food/beverage order process at a restaurant table, using electronic mobile devices connected to internet with capability to scan QR Codes scan and a web browser.

One of the exemplary embodiment of the invention provides ‘Host/Waiter QR Code’ on a restaurant table, which embeds unique table identifier and a hosted system URL. Upon scanning this QR Code by authenticated host/waiter using electronic mobile device, a request will be sent to a hosted system (computer server & software) over the internet that contains unique restaurant table identifier, authenticated host/waiter identifier. The response over the internet from the hosted system provides host/waiter option to ‘Open’ that specific table, so that the guests at that table can send valid food/beverage orders to a hosted system. Optionally the hosted system provides unique ‘Guest Security Code’ to the host/waiter, which is utilized by all guests at that table to initiate valid food/beverage orders. Configurations in a hosted system determines if and how ‘Guest Security Code’ is provided to guests in that specific restaurant. Scanning this host/waiter QR Code at this table by authenticated host/waiter, allows managing status and orders associated with that specific table.

Another exemplary embodiment of the invention provides ‘Guest QR Code’ on a restaurant table for each guest, which embeds unique ‘Guest Seat Identifier’ and hosted system URL. Upon scanning this QR Code by guest using electronic mobile device, a request is sent to the hosted system over the internet containing unique guest seat identifier. This starts the food/beverage order process for that specific guest. Scanning this ‘Guest QR Code’ at this table by a guest, allows managing status and orders associated with that specific guest seat.

Another exemplary embodiment of the invention provides ‘Item QR Code’ next to each item on the restaurant menu, which embeds unique menu ‘Item Identifier’ and hosted system URL. Upon scanning this QR Code by guest using electronic mobile device, a request is sent to hosted system. Response from a hosted system contains information about that item such as description, picture, short preparation video, chefs profile, ingredients and/or food allergy details. Response from a hosted system also contains ‘made to order’ and item selection options.

Another embodiment of the invention is a hosted system (computer server and software) connected to internet, provides required operations to support other embodiments of this invention.

Other objects and features will become apparent from the following detailed description considered in conjunction with accompanying drawings. It is to be understood, however, that the drawings are designed as illustration only and not as a definition of the limits of the invention.

### BRIEF DESCRIPTION OF DRAWINGS

FIG. 1 is the illustration of the host/waiter scanning a ‘Host/Waiter QR Code’ at a table using electronic mobile device, to open/close/change status of that table in a restaurant.

FIG. 2 is the illustration of a guest scanning ‘Guest QR Code’ using electronic mobile device, to initiate/manage food/beverage orders for that guest.

FIG. 3 is the illustration of a guest scanning ‘Item QR Code’ on a restaurant menu, to view information of that item or make selections.

FIG. 4 is showing steps of food/beverage order(s) process for the entire table at a restaurant.

FIG. 5 is the diagrammatic representation of waiter/host or chef/cook retrieving or updating food/beverage orders from a hosted system.

### DETAILED DESCRIPTION OF INVENTION

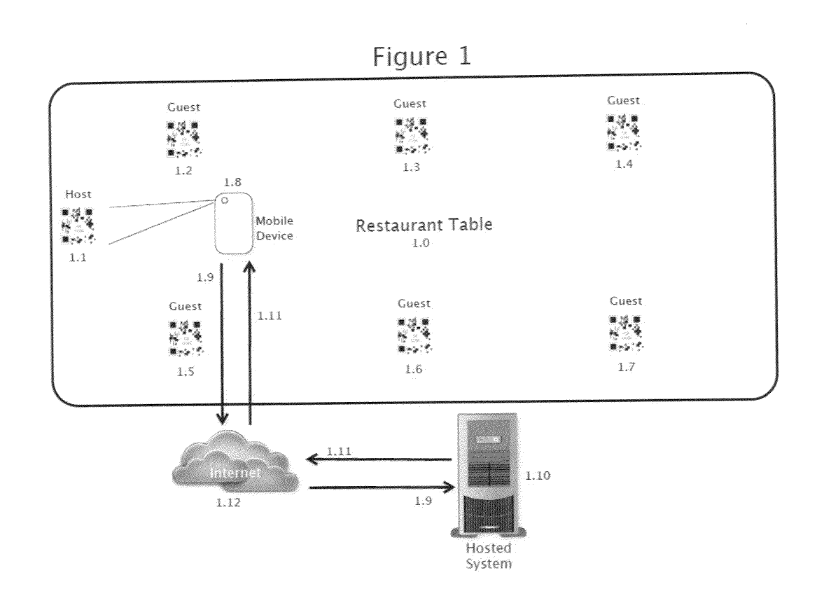

As illustrated in FIG. 1, ‘Host/Waiter QR Code’ (1.1) is placed on a restaurant table that embeds unique table identifier and hosted system (1.10) UR (Uniform Resource Locator). Upon scanning this host/waiter QR Code (1.1) at this table (1.0) by host/waiter using electronic mobile device (1.8), a https request (1.9) is sent to the hosted system (1.10) via internet (1.12) with unique table identifier and authenticated host/waiter unique identifier. Https response (1.11) from the hosted system (1.10) will allow host/waiter to open the table (1.0) for food/beverage orders by the guests seated (1.2, 1.3, 1.4, 1.5, 1.6, 1.7) at this table (1.0) or close the table (1.0) for food/beverage orders for the guests (1.2, 1.3, 1.4, 1.5, 1.6, 1.7) seated at this table (1.0) or change the status of this table (1.0). Optionally, http response (1.11) from the hosted system (1.10) includes ‘Guest Security Code’ that all guests (1.2, 1.3, 1.4, 1.5, 1.6, 1.7) seated at this table (1.0) use to initiate valid food/beverage orders, depending on configurations in a hosted system (1.10).

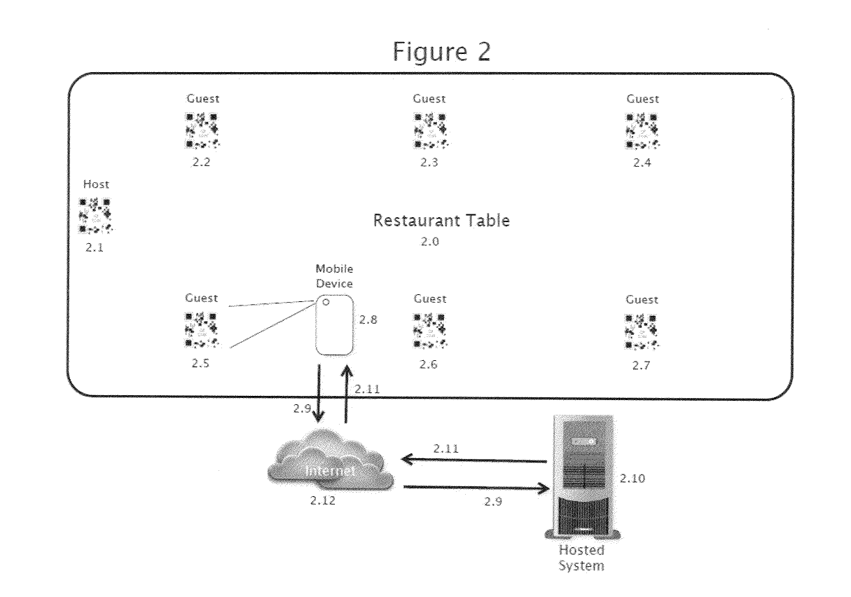

As illustrated in FIG. 2, guest QR Codes (2.2, 2.3, 2.4, 2.5, 2.6, 2.7) are placed on a restaurant table that each of them embeds unique guest seat identifier and hosted system (2.10) URL (Uniform Resource Locator). Upon scanning the guest QR Code by each of the guests (2.2, 2.3, 2.4, 2.5, 2.6, 2.7) at this table (2.0) using electronic mobile device (2.8), a https request (2.9) is sent to the hosted system (2.10) via internet (2.12) with a unique guest seat identifier and optional ‘Guest Security Code’ provided by the host/waiter at the table (2.0). Hosted system (2.10) validates https request (2.9) and initiates food/beverage order process for that guest by sending https response (2.11) and guest authentication code.

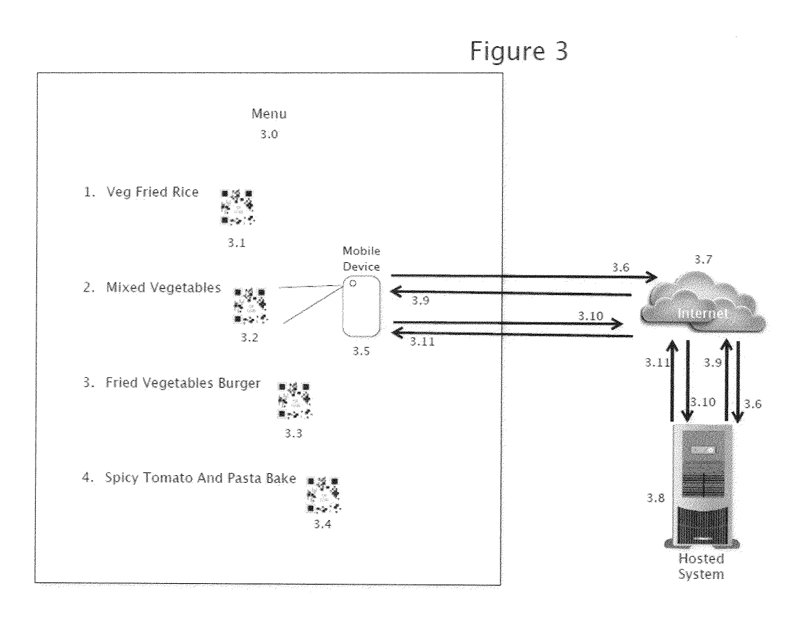

As illustrated in FIG. 3, item QR Codes (3.1, 3.2, 3.3, 3.4) placed on a restaurant menu (3.0) that each of them embeds unique ‘Item Identifier’ and hosted system (3.8) URL(Uniform Resource Locator). Upon scanning choice of item QR Codes (3.1, 3.2, 3.3, 3.4) by a guest using electronic mobile device (3.5), a https request (3.6) is sent to the hosted system (3.8) via internet (3.7) with a unique item identifier of that item and guest authentication code. Hosted system (3.8) validates https request (3.6) and sends https response (3.9) with item information(picture, short preparation video, ingredients, chef profile and/or allergy information), ‘made to order’(customizations) and selection options. Upon making the selection of that item using on screen options, a https request (3.10) is sent to the hosted system (3.8) via internet (3.7) with unique item identifier, item options, unique guest seat identifier and guest authentication code. Hosted system (3.8) validates https request (3.10) and adds that item to that guest order. Upon successful addition of the item to the guest order, hosted system (3.8) sends https response (3.11) with acknowledgement or error message if hosted system (3.8) fails to add the item to that guest order.

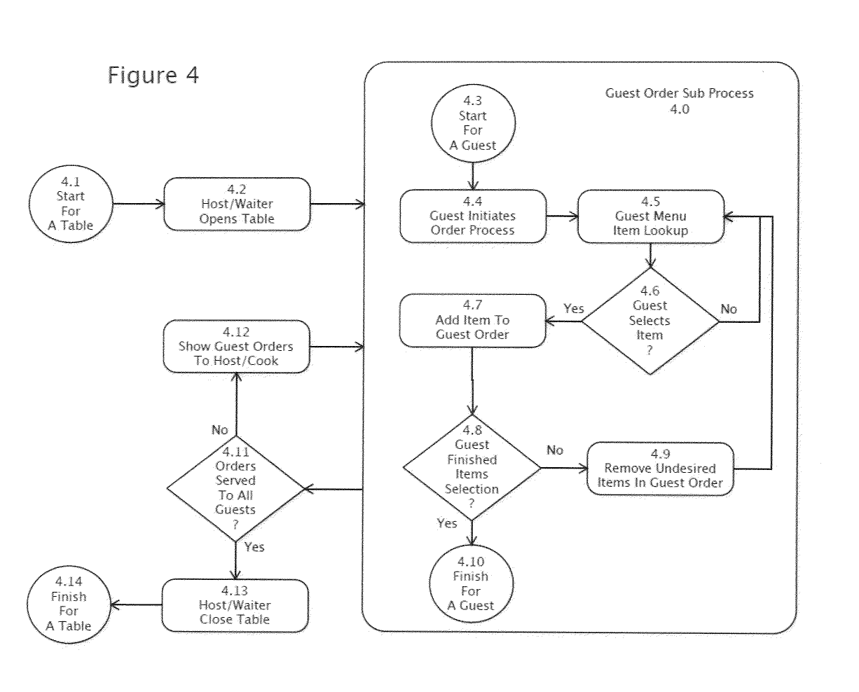

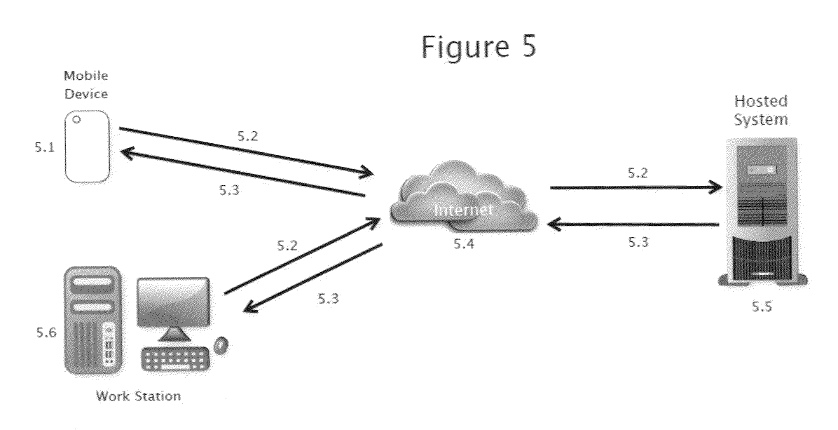

FIG. 4 is showing the steps of the food/beverage order process at the restaurant table. Food/beverage order process starts at step 4.1, for the entire table once the guests are seated by the host/waiter. Host/waiter ‘Opens Table’ in step 4.2, by scanning ‘Host QR Code’ as described in FIG. 1. Until the step 4.2 is performed, no guest can place valid food/beverage orders at that specific table. ‘Guest Order Sub Process’ 4.0, is showing the steps for each of the guest at the table. Each guest food/beverage order process starts at step 4.3. In step 4.4, each guest at that table initiates food/beverage order process by scanning the ‘Guest QR Code’ at the table that is specific to that guest seat, as described in FIG. 2. In step 4.5, each guest uses the restaurant menu provided by the host/waiter for food/beverage selection, as described in FIG. 3. When the guest select an item on the menu (step 4.6), that item is added to that guest order (step 4.7) as described in FIG. 3. Each guest performs from step 4.5, until all desired items are added (step 4.8). In step 4.9, guest can remove previously selected menu items, within the ‘Update/Delete Time Limit Constraint’ imposed by the hosted system parameters. Each guest finishes the food/beverage order process in step 4.10. Host/waiter waits until food/beverage orders to all the guests (step 4.11) are served, and then ‘Close Table’ in step 4.13 as described in FIG. 1. In step 4.12, guest orders are shown to host/waiter and cook/chef for preparation as described in FIG. 5. Food/beverage order process finishes at step 4.14 for that table where host/waiter collects payments from the guests or alternatively guest(s) can make payment using their electronic mobile device using options provided by host system.

As illustrated in FIG. 5, authenticated cook/chef or host/waiter can retrieve guest orders or update guest orders by sending https request (5.2) via internet(5.4) to the hosted system (5.5) using the options provided by the hosted system (5.5) on electronic mobile device (5.1) or workstation (5.6). Upon receiving https request (5.2), hosted system (5.5) performs validation and requested operation, then sends the https response (5.3) with the orders data or operation acknowledgement.

1. A method of food/beverage orders automation at a restaurant table, comprising:
‘Host/waiter QR Code (2D barcode)’ provided at each restaurant table;
‘Guest QR Code (2D barcode)’ provided at a restaurant table for each guest seat;
‘Item QR Code (2D barcode)’ provided for each item on a restaurant menu;
All the said QR Codes are associated to a restaurant in a hosted system;
Hosts/waiters, guests utilize said QR Codes at a restaurant by scanning them with electronic mobile device(s);
Hosted system that accepts, validates, stores, retrieves, updates food/beverage information, selections and orders for a restaurant;

2. The method of claim 1; wherein authenticated host/waiter scans ‘Host/Waiter QR Code’ at a table, to ‘Open a table’ for food/beverage orders by the guests at a said specific table.

3. The method of claim 2; wherein hosted system will receive a request to ‘Open a table’ for guests orders from the authenticated host/waiter and sends a response with ‘Guest Security Code’ that is utilized by all guests at a said specific table to place valid food/beverage orders, based on the configured rules.

4. The method of claim 3; wherein hosted system records status of a said table as ‘Open’ to receive subsequent food/beverage orders from guests at that said specific restaurant table, until the time the status of a said table changes to ‘closed’.

5. The method of claim 2; wherein hosted system provide options to authenticated host/waiter to retrieve or change status of guest seats at said specific table.

6. The method of claim 1; wherein each guest at a table scans ‘Guest QR Code’ provided at that table for that specific guest seat, to initiate food/beverage orders for a said guest.

7. The method of claim 6; wherein hosted system will receive a request to initiate food/beverage order for a guest at that specific seat at a table. Based on configured rules, hosted system prompts guest to enter ‘Guest Security Code’ provided by host/waiter for that specific table.

8. The method of claim 7; wherein hosted system will validate the request and initiates order process by responding with ‘Guest Authentication code’ for a guest at that specific seat.

9. The method of claim 8; wherein a said ‘Guest Authentication Code’ is sent along with every request sent to the hosted system from a guest at that specific seat at a table.

10. The method in claim 9; wherein hosted system validates authenticity of every request coming from a guest at that specific seat at a table, against ‘Guest Authentication Code’ generated for that specific guest seat at a table.

11. The method in claim 1; wherein guest scans ‘Item QR Code’ of their choice on the restaurant menu, to view information about that specific item or to make selection of that item.

12. The method in claim 11; wherein hosted system validates authenticity of the guest request and responds by sending item information, ‘made to order’ and selection options.

13. The method in claim 6; wherein hosted system provides options to a guest, to update or delete earlier item selections within the time limits set in the hosted system.

14. The method in claim 1; wherein hosted system provides options to authenticated chef/cook to retrieve and update food/beverage orders for a said specific restaurant.

15. The method in claim 2; wherein hosted system provides options to authenticated host/waiter, to retrieve and update food/beverage orders for said specific table.

16. The method in claim 2; wherein authenticated host/waiter scans ‘Host/Waiter QR Code’ at a table, to ‘Close a table’ for food/beverage orders by the guests at a said specific table once all orders at the table are delivered to the guests.

17. The method in claim 16; wherein hosted system receives a request to ‘Close a table’, that is validated and status for a said specific table is recorded as closed. Hosted system optionally generates and sends check(s) for payment as part of the response, based on the configuration in the hosted system.

18. A system of food/beverage orders automation at a restaurant table, comprising:
‘Host/Waiter QR Code’ that embeds unique identifier along with hosted system URL (Uniform Resource Locator), placed at each restaurant table;
‘Guest QR Code’ that embeds unique identifier along with hosted system URL, placed at each restaurant table seat;
‘Item QR Code’ that embeds unique identifier along with hosted system URL, placed on restaurant menu for each item;
Hosted System (Computer Server and Software) is connected to the internet which receives https requests and sends https responses, to perform operations required in food/beverage orders;
Electronic mobile devices connected to internet with a capability to scan QR Codes and a web browser.

19. A system in claim 18; wherein hosted system generates ‘Host/Waiter QR Codes’, ‘Guest QR Codes’ and ‘Item QR Codes’ with embedded unique identifiers and hosted system URL.

20. A system in claim 18; wherein hosted system provides web application by which authenticated restaurant administrators will setup restaurant information in a hosted system, which is stored in hosted system's database.

21. A system in claim 18; wherein all the QR Codes namely, ‘Host/Waiter QR Codes’, ‘Guest QR Codes’ and ‘Item QR Codes’ that are utilized in a specific restaurant are scanned by authenticated restaurant administrator(s) using electronic mobile device to associate them to a said specific restaurant and configure them in hosted system. A https request is sent to the hosted system along with authenticated administrator identifier, unique identifier embedded in QR Code, QR Code types(Host/Waiter, Guest, Menu Item) and operation type code.

22. A system in claim 21; wherein hosted system validates https requests made by restaurant administrator(s) and associates all unique identifiers received, with a said specific restaurant and records them in hosted system's database.

23. A system in claim 21; wherein ‘Host/Waiter QR Code’ placed at a table is scanned by authenticated restaurant administrator and associates with that said specific table, all ‘Guest QR Codes’ placed at the table for all the guest seats are scanned by authenticated restaurant administrator and associates with that specific table.

24. A system in claim 23; wherein authenticated restaurant administrator repeats process in claim 23 for all the tables in a specific restaurant.

25. A system in claim 18; wherein authenticated host/waiter scans ‘Host/Waiter QR Code’ using electronic mobile device which generates https request to hosted system with unique host identifier stored in the client web browser storage and unique table identifier embedded in the QR Code, to ‘Open a table’ for guest orders. Optionally, host system responds with a ‘Guest Security Code’ that is utilized by all the guests at that specific table to place valid food/beverage orders, based on configured rules.

26. A system in claim 25; where in host system validates the authenticity of the https request to ‘Open a table’ for guest orders. Host system records that specific table as ‘Open’ for guests orders. Based of the configuration in the host system, a ‘Guest Security Code’ is generated and sent with https response. Generated ‘Guest Security Code’ is associated with that specific table.

27. A system in claim 18; wherein a guest scans ‘Guest QR Code’ placed at that specific guest seat using electronic mobile device, to initiate food/beverage orders for that specific guest. A https request to hosted system is generated with ‘Unique Guest Seat Identifier’ embedded in that ‘Guest QR Code’. Optionally, hosted system prompts for a ‘Guest Security Code’. A successful https response from host system includes unique ‘Guest Authentication Code’, that is stored in that client web browser storage without revealing it to that guest along with ‘Unique Guest Seat Identifier’.

28. A system in claim 27; wherein hosted system checks authenticity and validity of https request from a guest, initiates food/beverage order by generating unique ‘Guest Authentication Code’ as part https response.

29. A system in claim 28; wherein hosted system checks the authenticity of https request from guest with ‘configured authenticity rules’ and optional ‘Guest Security Code’, checks validity with ‘configured validity rules’ and considers valid only if that specific table is in ‘Open’ status for guest orders.

30. A system in claim 18; wherein guest scans choice of ‘Item QR Code’ on a restaurant menu with electronic mobile device generating a https request with a unique item identifier embedded in ‘Item QR Code’, unique ‘Guest Authentication Code’ stored in client browser storage and ‘Unique Guest Seat Identifier’ stored in client browser storage. A successful https response from hosted system includes item information, ‘made to order’ and item selection options.

31. A system in claim 30; wherein hosted system determines ‘Item Update Time Constraint’ based on the configured rules and sends it to a guest with https response. Update/delete of a selected item by a guest is allowed by host system within the time limits set by ‘Item Update Time Constraint’.

32. A system in claim 30; wherein hosted system provides ‘made to order’ item suggestions to a guest based on that item orders history.

33. A system in claim 30; wherein hosted system checks authenticity of https request from a guest with ‘configured authenticity rules’ and validate with ‘configured validation rules’ and records item selection as part of that guest order.

34. A system in claim 18; wherein hosted system provides options to authenticated cooks/chefs to retrieve and update food/beverage orders recorded in the system that cross past the ‘Item Update Time Constraint’ as mentioned in ‘claim 31’.

35. A system in claim 18; wherein authenticated host/waiter scans ‘Host/Waiter QR Code’ using electronic mobile device which generates https request to hosted system with unique host identifier stored in the client web browser storage and unique table identifier embedded in the QR Code, to ‘Close a table’ for guest orders that is ‘Open’ previously.

36. A system in claim 35; wherein hosted system checks authenticity and validity of the https request from host/waiter. That specific table is recorded with ‘Close’ status, using unique table identifier in the https request. Hosted system invalidates all https requests for food/beverage orders from guests at this said specific table, after recording it with ‘Close’ status. Based on the set configurations, hosted system generates guest check(s) for payment for this specific table.
